(19) United States
(12) Patent Application Publication
(10) Pub. No.: US 2006/0187145 A1
(43) Pub. Date: Aug. 24, 2006

(54) Plasma display panel, plasma display apparatus, driving apparatus of the panel and driving method of the apparatus

(76) Inventor: Jin Hee Jeong, Seongnam-si (KR)

Correspondence Address: MCKENNA LONG & ALDRIDGE LLP;Song K. Jung, 1900 K Street, N.W., Washington, DC, 20006, US

(21) Appl. No.: 11/319,064

(22) Filed: Dec. 28, 2005

(30) Foreign Application Priority Data
Feb. 23, 2005 (KR) 10-2005-0014963

(51) Int. Cl. G09G 3/28

(52) U.S. Cl. 345/60

(57) ABSTRACT

The present invention relates to a plasma display panel, a plasma display apparatus, a driving apparatus of the plasma display panel and a driving method of the plasma display apparatus. The plasma display apparatus of the present invention comprises a plasma display panel comprising a plurality of scan electrodes, a scan driver for driving the scan electrodes and a scan pulse controller for controlling the scan driver to set the width of a scan pulse applied to the scan electrodes in an address period of at least one of a plurality of sub-fields to be less than a first critical time.

### CROSS-REFERENCE TO RELATED APPLICATIONS

This Nonprovisional application claims priority under 35 U.S. C. §119(a) on Patent Application No. 10-2005-0014963 filed in Korea on Feb. 23, 2005 the entire contents of which are hereby incorporated by reference.

### BACKGROUND OF THE INVENTION

1. Field of the Invention

The present invention relates to a plasma display apparatus, and more particularly, to a plasma display panel, a plasma display apparatus, a driving apparatus for the panel and a driving method for the apparatus, in which the width of a scan pulse applied to scan electrodes in an address period is controlled.

2. Background of the Related Art

In a conventional plasma display panel, a barrier rib formed between a front panel and a rear panel forms one unit cell. Each cell is filled with a primary discharge gas, such as neon (Ne), helium (He) or a mixed gas of Ne and He, and an inert gas containing a small amount of xenon. If the inert gas is discharged with a high frequency voltage, it generates vacuum ultraviolet rays. The vacuum ultraviolet rays excite phosphors formed between the barrier ribs, thus generating images. This plasma display panel can be manufactured to be thin, and has been considered one of the next-generation display devices.

FIG. 1 illustrates the construction of a conventional plasma display panel.

Referring to FIG. 1, the plasma display panel comprises a front panel 100 and a rear panel 110. In the front panel 100, a plurality of sustain electrode pairs in which a plurality of scan electrodes 102 and sustain electrodes 103 form pairs is arranged on a front glass 101, i.e., a display surface on which images are displayed. In the rear panel 110, a plurality of address electrodes 113 disposed to cross the plurality of sustain electrode pairs is arranged on a rear glass 111, i.e., a rear surface. The front panel 100 and the rear panel 110 are parallel to each other with a predetermined distance therebetween.

The front panel 100 comprises the pairs of scan electrodes 102 and sustain electrodes 103, which mutually discharge the other and maintain the emission of a cell in one discharge cell. In other words, each of the scan electrode 102 and the sustain electrode 103 each have a transparent electrode “a” made of a transparent ITO material and a bus electrode “b” made of a metal material. The scan electrodes 102 and the sustain electrodes 103 are covered with one or more upper dielectric layers 104 for limiting the discharge current and providing insulation among electrode pairs. A protection layer 105 having magnesium oxide (MgO) deposited thereon is formed on the dielectric layers 104 to facilitate a discharge condition.

In the rear panel 110, barrier ribs 112 of stripe form (or well form), for forming a plurality of discharge spaces, i.e., discharge cells are arranged parallel to one another. A plurality of address electrodes 113, which generate vacuum ultraviolet rays by performing an address discharge, are disposed parallel to the barrier ribs 112. R, G and B phosphors 114 that emit a visible ray for displaying images during an address discharge are coated on the top surface of the rear panel 110. A low dielectric layer 115 for protecting the address electrodes 113 is formed between the address electrodes 113 and the phosphors 114.

A method of generating gray level images in this plasma display panel will now be described with reference to FIG. 2.

FIG. 2 illustrates a method of generating gray level images in the conventional plasma display panel.

As shown in FIG. 2, to represent gray level images in a conventional plasma display panel, one frame is divided into several sub-fields having a different number of emissions. Each sub-field is subdivided into a reset period RPD for initializing the entire cells, an address period APD for selecting a cell to be discharged, and a sustain period SPD for implementing gray levels depending on the number of discharges. For example, to display images with 256 gray levels, a frame period (16.67 ms) corresponding to 1/60 seconds is divided into eight sub-fields SF1 to SF8, as shown in FIG. 2. Each of the eight sub-fields SF1 to SF8 is again divided into a reset period, an address period and a sustain period.

The reset period and the address period of each sub-field are the how for every sub-field. An address discharge for selecting a cell to be discharged is generated due to a voltage difference between the address electrodes and the scan electrodes, i.e., transparent electrodes. In this case, the sustain period increases in the ratio of 2ⁿ (where, n=0,1,2,3,4,5,6,7) in each sub-field. As described above, since the sustain period is changed in each sub-field, gray level images are represented by controlling the sustain period of each sub-field, i.e., a sustain discharge number.

The method of implementing images gray levels of the plasma display panel is generally classified into a selective writing mode and a selective erasing mode depending on whether a selected discharge cell is excited by an address discharge.

In the selective writing mode, after the entire screen is turned off in the reset period, selected discharge cells are turned on in the address period. In the sustain period, the discharged discharge cells, which are selected by an address discharge, remain turned on, thus displaying images.

In the selective writing mode, the width of a scan pulse is; set to be relatively wide, so that a sufficient amount of wall charges are formed within the discharge cells. If the width of the scan pulse becomes too wide, however, problems arise in that the address period becomes too wide and the sustain period contributing to brightness becomes relatively narrow.

In the selective erasing mode, after the entire screen is turned on through a write discharge in the reset period, selected discharge cells are turned off in the address period. Thereafter, in the sustain period, only the discharge cells which were not selected by the address discharge undergo a sustain discharge, thus displaying images.

In such selective erasing mode, the width of the scan pulse is set to be relatively narrow, so that an erase discharge is generated in the discharge cells. That is, in selective erasing mode, the address period can be set to be short by applying a scan pulse with a narrow width. Accordingly, a relatively large amount of time can be allocated to the sustain period, thus, contributing to brightness. The selective erasing mode is, however, disadvantageous in that contrast is too low since the entire screen is turned on in the reset period, i.e., a non-display period.

To overcome the disadvantages of the selective writing and erasing modes, a method in which a selective writing mode and a selective erasing mode are combined has been proposed.

FIG. 3 shows one frame of an exemplary conventional plasma display panel in which sub-fields of a selective writing and a selective erasing mode are comprised in one frame.

As shown in FIG. 3, one frame comprises a selective writing sub-field (WSF) having at least one or more sub-fields, and a selective erasing sub-field (ESF) having at least one or more sub-fields.

The selective writing sub-field (WSF) comprises an m number of sub-fields SF1 to SFm (where, m is a positive integer greater than 0). Each of the first to the (m−1)^{th} sub-fields SF1 to SFm−1 except for an m^{th} sub-field SFm is divided into a reset period for uniformly forming a constant amount of wall charges in cells of the entire screen, a selective writing address period (hereinafter, referred to as a “writing address period”) for selecting on cells using a write discharge, a sustain period for generating a sustain discharge in the selected on cells, and an erase period for erasing wall charges within the cells after the sustain discharge.

The m^{th} sub-field SFm, i.e., the last sub-field of the selective writing sub-field (WSF) is divided into a reset period, a writing address period and a sustain period. The reset period, the writing address period and the erase period of the selective writing sub-field (WSF) are the same in each of sub-fields SF1 to SFm, but the sustain period thereof can be the same or different in a predetermined brightness weight.

The selective erasing sub-field (ESF) comprises an n through m number of sub-fields (SFm+1 to SFn) (where, n is a positive integer greater than m). Each of the (m+1)^{th} to n^{th} sub-fields (SFm+1 to SFn) is divided into a selective erasing address period (hereinafter, referred to as a “erasing address period”) for selecting off cells using an erase discharge, and a sustain period for generating a sustain discharge in on cells. In the sub-fields (SFm+1 to SFn) of the selective erasing sub-field (ESF), the erasing address period is the how, but the sustain period thereof can be the same or different depending upon the relative brightness ratio.

In the method shown in FIG. 3, the address period can be set to be short and the contrast can also be improved in a way to drive the m number of sub-fields in the selective writing mode and the n through m number of the sub-fields in the selective erasing mode. In other words, since one frame comprises the selective erasing sub-field with a short scan pulse, a sufficient sustain period can be secured. Furthermore, since one frame comprises the selective erasing sub-field without a reset period, contrast can be improved.

A driving waveform depending on the driving method of the plasma display panel will be described with reference to FIG. 4 by using the selective writing mode as an example.

FIG. 4 shows an example of a driving waveform in a driving method of a conventional plasma display panel.

As shown in FIG. 4, the plasma display panel is driven with it being divided into a reset period for initializing all of the cells, an address period for selecting cells to be discharged, a sustain period for sustaining the discharge of the selected cells, and an erase period for erasing wall charges within the discharged cells.

In a set-up period of the reset period, a ramp-up waveform (Ramp-up) is applied to all of the scan electrodes at the same time. The ramp-up waveform generates a weak dark discharge within the discharge cells of the entire screen. The set-up discharge causes positive wall charges to be accumulated on the address electrodes and the sustain electrodes and negative wall charges to be accumulated on the scan electrodes.

In a set-down period of the reset period, after the ramp-up waveform is applied, a ramp-down waveform (Ramp-down), which starts falling from a positive voltage lower than a peak voltage of the ramp-up waveform down to a predetermined voltage level lower than a ground (GND) level voltage, generates a weak erase discharge within cells, thereby sufficiently erasing wall charges excessively formed on the scan electrodes. The set-down discharge causes wall charges of a degree that a stable address discharge will occur to uniformly remain within the cells.

In the address period, while a negative scan pulse is sequentially applied to the scan electrodes, a positive data pulse is applied to the address electrodes in synchronization with the scan pulse. As the voltage difference between the scan pulse and the data pulse and a wall voltage generated in the reset period are added together, an address discharge is generated within the discharge cells to which the data pulse is applied. Wall charges of the degree in which a discharge can occur when a sustain voltage (Vs) is applied are formed within cells selected by an address discharge. The sustain electrode is supplied with a positive polarity voltage (Vz) such that an erroneous discharge is not generated between the sustain electrode and the scan electrodes by reducing between the sustain electrode and the scan electrodes during the set-down period and the address period.

In the sustain period, a sustain pulse (sus) is alternately applied to the scan electrodes and the sustain electrode. In cells selected by an address discharge, a sustain discharge, i.e., a display discharge that is generated between the scan electrodes and the sustain electrodes whenever a sustain pulse is applied as the wall voltage within the cell and the sustain pulse are added.

After the sustain discharge finishes, in the erase period, a voltage of an erase ramp waveform (Ramp-ers) with a narrow pulse width and a low voltage level is applied to the sustain electrodes, thereby erasing wall charges remaining within the cells of the entire screen.

In the conventional plasma display panel driven according to this driving waveform, in sub-fields of the entire frames, the width of a scan pulse (Vsc) applied to the scan electrodes in the address period is the same in the entire sub-fields. The width of the conventional scan pulse will be described with reference to FIG. 5.

FIG. 5 illustrates the width of the scan pulse applied in the address period in the driving method of the conventional plasma display panel.

As shown in FIG. 5, in the driving method of the conventional plasma display panel, the width of the scan pulse applied in the address period is set to be the same, i.e., “W”. In other words, the width of a scan pulse applied in the address period in a sub-field implementing a low gray level because of its relatively low weight and a sub-field implementing a high gray level because of its relatively high weight is the same.

The width of the scan pulse applied in the address period is one of the most important factors affecting the generation of wall charges within discharge cells. The greater the width of the scan pulse (Vsc), which inversely falls from the end of the set-down pulse to a scan reference voltage, the longer the time an address discharge continues. Accordingly, a greater amount of wall charges are generated within discharge cells.

In the related art, however, the width of a scan pulse applied in the address period is set to be the same in all of the sub-fields regardless of sub-fields weight. Accordingly, there is a high probability that an address discharge may become unstable in an initial sub-field, i.e., a sub-field with a relatively low weight. As a result, there is a problem in that a jitter characteristic, i.e., an address discharge delay phenomenon is poor.

In a sub-fields implementing a low gray level, an address discharge is unstable and the number of sustain pulses is small, compared to sub-fields implementing a high gray level. Accordingly, there is a possibility that a sustain discharge may become unstable since the amount of wall charges accumulated within the discharge cells is insufficient for the sustain discharge due to the unstable address discharge. In view of such a sustain discharge characteristic, the distribution of wall charges within discharge cells must be set to be advantageous for the sustain discharge by generating a stable address discharge in the address period.

In the related art, however, the width of a scan pulse applied in the address period is the same in all of the sub-fields regardless of the subfield weight. Therefore, the distribution of wall charges within the discharge cells after an address discharge is insufficient in an initial sub-field, which has a high possibility that an address discharge may become unstable, i.e., a sub-field with a relatively weight. Accordingly, problem arises in that a sustain discharge becomes unstable or a sustain discharge is not generated.

### SUMMARY OF THE INVENTION

Accordingly, the present invention has been made in view of the above problems occurring in the prior art, and it is an object of the present invention to provide a plasma display panel, a plasma display apparatus, a driving apparatus of the panel and a driving method of the apparatus, in which a driving pulse applied in a set-down period of a reset period and an address period is improved.

To achieve the above object, according to the present invention, there is provided a plasma display apparatus comprising a plurality of scan electrodes, a scan driver for driving the scan electrodes and a scan pulse controller for controlling the scan driver to set the width of a scan pulse applied to the scan electrodes in an address period of at least one of a plurality of sub-fields to be less than a first critical time.

the first critical time is 1.1 μs.

the scan pulse controller controls the width of a scan pulse applied to the scan electrodes in an address period of at least one of the remaining sub-fields, other than a sub-field in which the width of a scan pulse applied to the scan electrodes in an address period is set to be less than the first critical time, of the plurality of sub-fields, to be more than a second critical time.

the second critical time is twice the first critical time.

the first critical time is 2.0 μs.

a subfield in which the scan pulse whose width is more than the second critical time is applied to the scan electrode in the address period is from the lowest weight subfield to a predetermined number of subfields in ascending order of weight.

a sub-field in which the scan pulse whose width is more than the second critical time is applied to the scan electrodes in the address period is from the lowest weight subfield to a third sub-field in ascending order of weight.

a sub-field in which the width of the scan pulse applied to the scan electrodes in the address period is more than the second critical time is plural, and the scan pulse controller sets the width of the scan pulse applied to the scan electrodes in the address period of at least one of the plurality of sub-fields to be different from the width of the scan pulse in remaining sub-fields.

a sub-field in which the width of the scan pulse applied to the scan electrodes in the address period is more than the second critical time is plural, and the scan pulse controller sets the width of the scan pulse applied to the scan electrodes in the address period to be different from each other on a sub-field basis, in the plurality of sub-fields.

the scan pulse controller increases the width of the scan pulse applied to the scan electrodes in the address period as the weight, in the plurality of sub-fields in which the width of the scan pulse applied to the scan electrodes in the address period is different from each other on a sub-field basis.

a sub-field in which the width of a scan pulse applied to the scan electrodes in an address period is set to be over the second critical time, of the plurality of sub-fields uses the number of sustain pulses, which is less than a critical number of sustain pulses.

the critical number is 50% or less of a total number of sustain pulses used in one frame.

the critical number is 30% or less of a total number of sustain pulses used in one frame.

a sub-field in which the width of the scan pulse applied to the scan electrodes in the address period is less than the first critical time is a selective writing sub-field or a selective erasing sub-field.

a sub-field in which the width of the scan pulse applied to the scan electrodes in the address period is over the second critical time is a selective writing sub-field or a selective erasing sub-field.

### BRIEF DESCRIPTION OF THE DRAWINGS

Further objects and advantages of the invention can be more fully understood from the following detailed description taken in conjunction with the accompanying drawings in which:

FIG. 1 illustrates the construction of a conventional plasma display panel;

FIG. 2 illustrates a method for implementing gray level images in the conventional plasma display panel;

FIG. 3 shows one frame of an exemplary conventional plasma display panel in which sub-fields of selective writing and selective erasing mode are comprised in one frame;

FIG. 4 shows an example of a driving waveform in a driving method of the conventional plasma display panel;

FIG. 5 illustrates the width of a scan pulse applied in an address period in a driving method of the conventional plasma display panel;

FIG. 6 shows the construction of a plasma display apparatus according to the present invention;

FIG. 7 illustrates an embodiment of a driving method of a plasma display panel according to the present invention;

FIGS. 8a and 8b illustrate a driving method in which the width of a scan pulse applied to scan electrodes in an address period is more than a second critical time in a plurality of sub-fields; and

FIGS. 9a and 9b illustrate the relationship of a scan pulse between sub-fields in which the width of the scan pulses applied to scan electrodes in an address period is over a second critical time; and

FIGS. 10a and 10b illustrate a driving method when sub-fields of one frame comprise both sub-fields of the selective writing mode and sub-fields of the selective erasing mode.

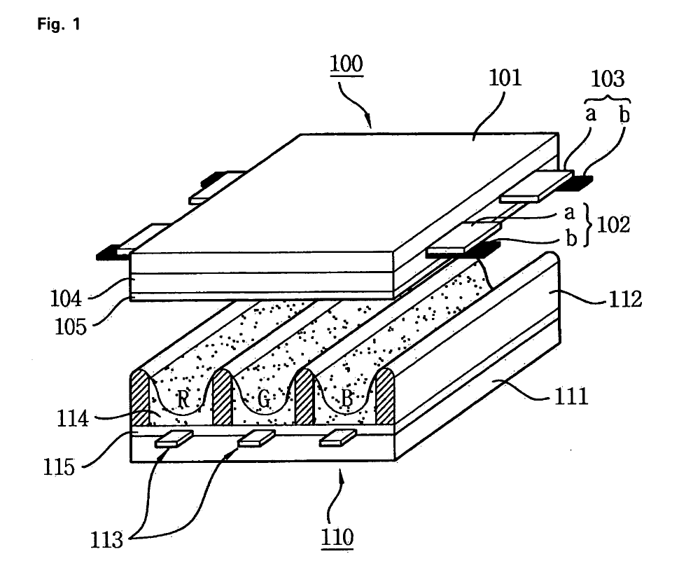

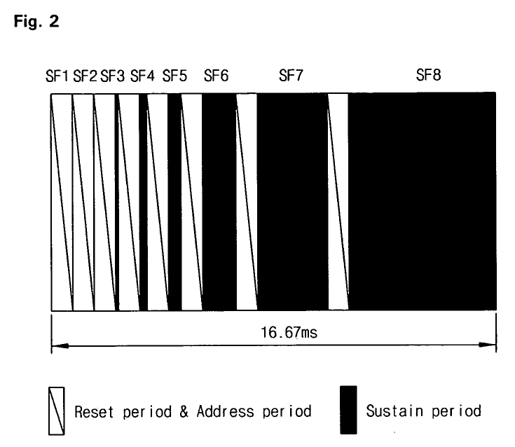

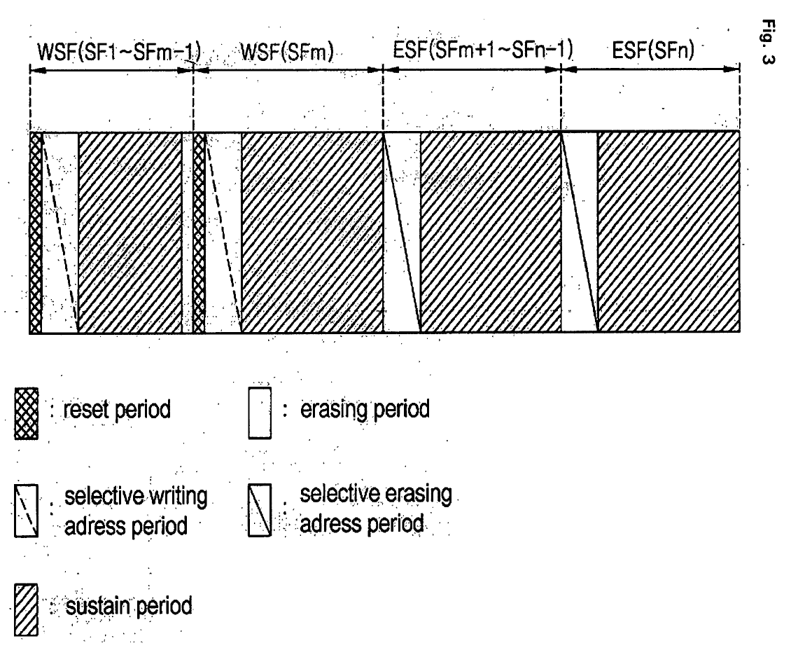

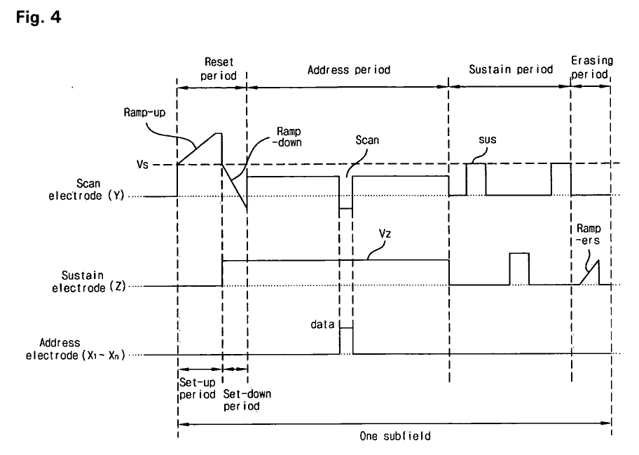

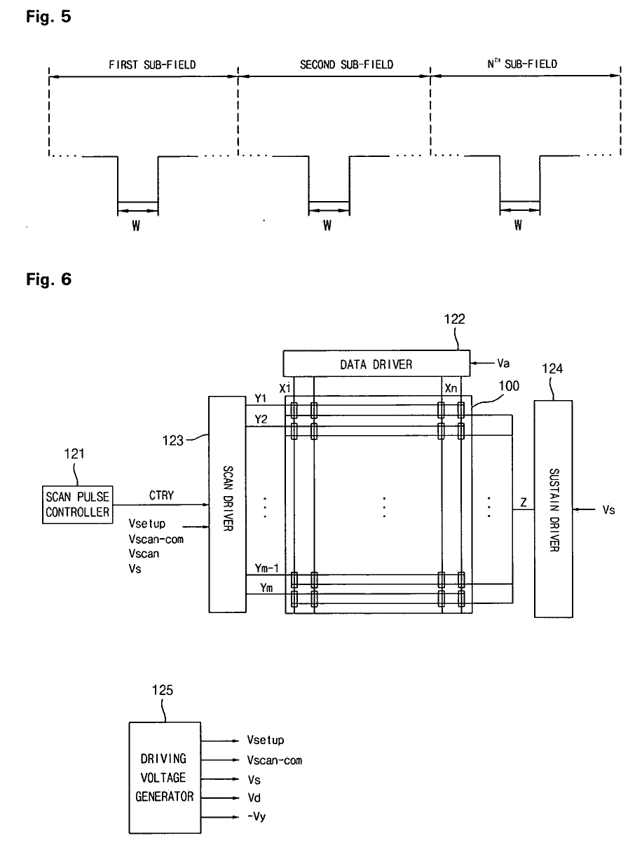

### DETAILED DESCRIPTION OF THE PREFERRED EMBODIMENT

The present invention will now be described in detail in connection with preferred embodiments with reference to the accompanying drawings.

FIG. 6 shows the construction of a plasma display apparatus according to the present invention.

As shown in FIG. 6, the plasma display apparatus according to the present invention comprises a plasma display panel 100 on which images comprised of frames are displayed by means of a combination of at least one or more sub-fields in which driving pulses are applied to address electrodes X1 to Xm, scan electrodes Y1 to Yn and a sustain electrode Z in a reset period, an address period and a sustain period, a data driver 122 for applying data to the address electrodes X1 to Xm formed in a rear panel (not shown) of the plasma display panel 100, a scan driver 123 for driving the scan electrodes Y1 to Yn, a sustain driver 124 for driving the sustain electrodes Z, i.e., a common electrode, a scan pulse controller 121 for controlling the scan driver 123 when the plasma display panel 100 is driven, and a driving voltage generator 125 for applying driving voltages necessary for the drivers 122, 123 and 124, respectively.

This plasma display apparatus according to the present invention displays images comprised of a frame by means of a combination of at least one or more sub-fields in which driving pulses are applied to the address electrodes, the scan electrodes and the sustain electrodes in the reset period, the address period and the sustain period. The width of a scan pulse applied to the scan electrodes in the address period of one sub-field of this frame is set to be a first critical time or less. The first critical time can be 1.1 μs. The reason why the first critical time is set to 1.1 μs as described above will be described in detail later on.

The above-described plasma display panel 100 comprises a front panel (not shown) and a rear panel (not shown), which are disposed parallel to each other with a predetermined distance therebetween. A number of electrodes, such as the scan electrodes Y1 to Yn and the sustain electrode Z, are formed in pairs on the front panel. The address electrodes X1 to Xm disposed to intersect the scan electrodes Y1 to Yn and the sustain electrode Z are formed on the rear panel.

Data, which undergoes inverse gamma correction and error diffusion through an inverse gamma correction circuit (not shown), an error diffusion circuit (not shown) and the like, are then mapped to the respective sub-fields by a sub-field mapping circuit (not shown) and are supplied to the data driver 122. The data driver 122 samples and latches the data in response to a timing control signal (CTRX) from a timing controller (not shown) and then supplies the data to the address electrodes X1 to Xm.

The scan driver 123 supplies a ramp-up waveform (Ramp-up) and a ramp-down waveform (Ramp-down) to the scan electrodes Y1 to Yn during the reset period under the control of the scan pulse controller 121. The scan driver 123 sequentially supplies a scan pulse (Sp) of a scan voltage (-Vy) to the scan electrodes Y1 to Yn during the address period, and supplies a sustain pulse (sus) to the scan electrodes Y1 to Yn during the sustain period, under the control of the scan pulse controller 121. The width of a scan pulse applied to the scan electrodes Y1 to Yn in the address period can be set to 1.1 μs or less in one sub-fields in a frame, and the width of a scan pulse applied to the scan electrodes Y1 to Yn during the address period in a sub-field with a low gray level can be set to be twice or higher than the width of the scan pulse in the remaining sub-fields.

The reason why the width of the scan pulse is set to 1.1 μs or less as described above because in the case of implementing an Extended Graphic Array (XGA)-grade panel to implement a High Definition (HD)-grade picture quality, the number of discharge cells in the XGA-grade panel is significantly greater than in a Video Graphic Array (VGA)-grade panel. In order words, to address a greater number of discharge cells within a limited address period, the width of the scan pulse is set to 1.1 μs or less. In this case, if the width of the scan pulse exceeds 1.1 μs, the length of the entire address period is increased and the length of a sustain period is decreased accordingly. Consequently, the number of sustain pulses applied in the sustain period is reduced, resulting in a reduction of the absolute brightness of the plasma display panel. For this reason, the width of the scan pulse is set to 1.1 μs or less.

The width of a scan pulse applied to the scan electrodes during the address period in a sub-field with a low gray level is set to be twice or higher than those of the remaining sub-fields because a sub-field of a low weight a high probability that an address discharge may become unstable compared to a sub-field having a high weight. Accordingly, when the width of the scan pulse applied to the scan electrodes in the address period is too narrow, an address discharge becomes unstable, address jitter deteriorates and a subsequent sustain discharge becomes unstable. That is, an address discharge in a sub-field having a low weight is stabilized by increasing the width of the scan pulse applied in the address period in a sub-field having a low weight.

The width of the scan pulse is set to be over the second critical time in the sub-field having the low weight will be described as follows. The number of sustain pulses in a sub-field with a low gray level is less than other sub-fields with a high gray level. Accordingly, since the amount of wall charges accumulated within discharge cells becomes less, there is a possibility that a sustain discharge may become unstable. For this reason, the width of a scan pulse is set to be greater than that of other sub-fields so that a stable address discharge is generated in the address period. Accordingly, the distribution of wall charges within discharge cells can be more advantageous for a sustain discharge.

The term “low gray level” refers to a gray level value in sub-fields having a relatively low brightness weight where gray levels are represented with a brightness weight being given every sub-field when the plasma display panel 100 is driven with it being divided into a plurality of sub-fields.

The sustain driver 124 applies a bias voltage of a sustain voltage (Vs) to the sustain electrodes Z during the period where the ramp-down waveform (Ramp-down) is generated and during the address period and also applies a sustain pulse (sus) to the sustain electrodes Z while operating in conjunction with the scan driver 123 during the sustain period, under the control of the timing controller (not shown).

The scan pulse controller 121 generates an operating timing of the scan driver 123 and a timing control signal (CTRY) for controlling synchronization in the reset period, the address period and the sustain period, and applies the timing control signal (CTRY) to the scan driver 123, thus controlling the scan driver 123. More particularly, the scan pulse controller 121 supplies a control signal, which sets the width of a scan pulse applied to the scan electrodes in the address period, in at least one of a plurality of sub-fields, to 1.1 μs or less, and controls the width of a scan pulse applied to the scan electrodes in the address period in the remaining sub-fields where the width of the scan pulse is not set to 1.1 μs or less, i.e., sub-fields with a low gray level to be greater than those of the remaining sub-fields to the scan driver 123. The scan pulse controller 121 supplies a control signal, which controls the width of a scan pulse applied to the scan electrodes in the address period of sub-fields with a low gray level to be greater than those of the remaining sub-fields to the scan driver 123.

The data control signal (CTRX) comprises a sampling clock for sampling data, a latch control signal, and a switch control signal for controlling an on/off time of an energy recovery circuit and a driving switch element. A scan control signal (CTRY) comprises a switch control signal for controlling an on/off time of an energy recovery circuit and a driving switch element within the scan driver 123. A sustain control signal (CTRZ) comprises a switch control signal for controlling an on/off time of an energy recovery circuit and a driving switch element within the sustain driver 124.

The driving voltage generator 125 generates a set-up voltage (Vsetup), a common scan voltage (Vscan-com), a scan voltage (-Vy), a sustain voltage (Vs), a data voltage (Vd) and the like. These driving voltages may vary depending upon the composition of a discharge gas or the structure of a discharge cell.

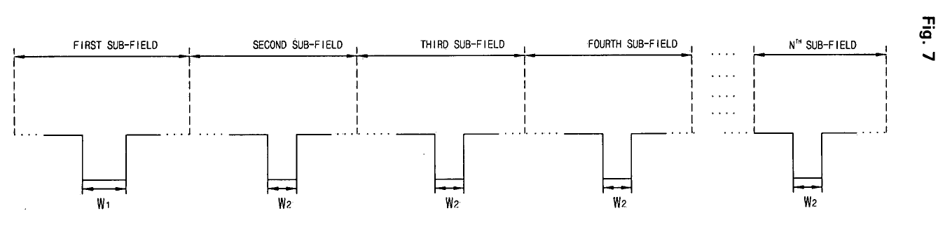

An embodiment of a driving method performed by the plasma display apparatus according to the present invention will be described with reference to FIG. 7.

FIG. 7 illustrates an embodiment of a driving method of a plasma display panel according to the present invention.

As shown in FIG. 7, in the driving method of the plasma display panel on which images comprised of frames are displayed by means of a combination of at least one or more sub-fields in which driving pulses are applied to the address electrodes, the scan electrodes and the sustain electrode in the reset period, the address period and the sustain period, the width of a scan pulse applied in an address period of one of sub-fields of a frame is set to be less than a first critical time.

For example, as shown in FIG. 7, assuming that the width of a scan pulse applied to the scan electrodes in the address period in a first sub-field is W1 and the width of a scan pulse applied to the scan electrodes in subsequent sub-field, i.e., from a second sub-field to an n^{th} sub-field is W2, the aforementioned first critical time can be 1.1 μs and W2 can be 1.1 μs or less accordingly. In FIG. 7, the width of the scan pulse applied to the scan electrodes in the address period of the remaining sub-fields other than the first sub-field is set to be 1.1 μs or less.

The reason why the width of a scan pulse applied to the scan electrodes in the address period in one of sub-fields of a frame is set to be 1.1 μs or less, as described above, has already been described with reference to FIG. 6. Description thereof will be omitted.

In at least one of the remaining sub-fields, other than a sub-field in which the width of a scan pulse applied to the scan electrodes in the address period is set to be less than the first critical time, of the sub-fields of the frame, the width of: a scan pulse applied to the scan electrodes in the address period is set to be over a second critical time. For example, as shown in FIG. 7, the width W2 of the scan pulse applied to the scan electrodes during the address period in the first sub-field may not be set to be less than the first critical time, but the width of the scan pulse applied to the scan electrodes in the address period can be set to be over the second critical time. In this case, the above-mentioned second critical time can be twice of the first critical time and the second critical time can be 2.0 μs.

As described above, sub-fields in which the width of the scan pulse applied to the scan electrodes during the address period is not less than the first critical time, but is over the second critical time, of the sub-fields of the frame, can be sub-fields implementing a low gray level due to its relatively low weight.

As mentioned in the description with reference to FIG. 6, the width of a scan pulse is set to 1.1 μs or less to effectively address the XGA-grade panel with a high picture quality such as HD grade picture quality. As described above, to implement a high picture quality, predetermined discharge cells must be all address within a limited address period. In the description with reference to FIG. 7, however according to the present invention, the reason why the width of a scan pulse applied to the scan electrodes during the address period of one of the sub-fields of a frame, i.e., a sub-field having a low weight is not set to less than the first critical time, but is set to over the second critical time is to stabilize an address discharge in sub-fields having a low weight.

As described above, a sub-field with a low gray level is greater than other sub-fields with a high gray level in which an address discharge may become unstable. For this reason, the width of the scan pulse applied to the scan electrodes during the address period in the sub-field having a low weight is set to over the second critical time to stabilize the address discharge. Accordingly, address jitter will be improved and a sustain discharge in a subsequent sustain period will be stabilized.

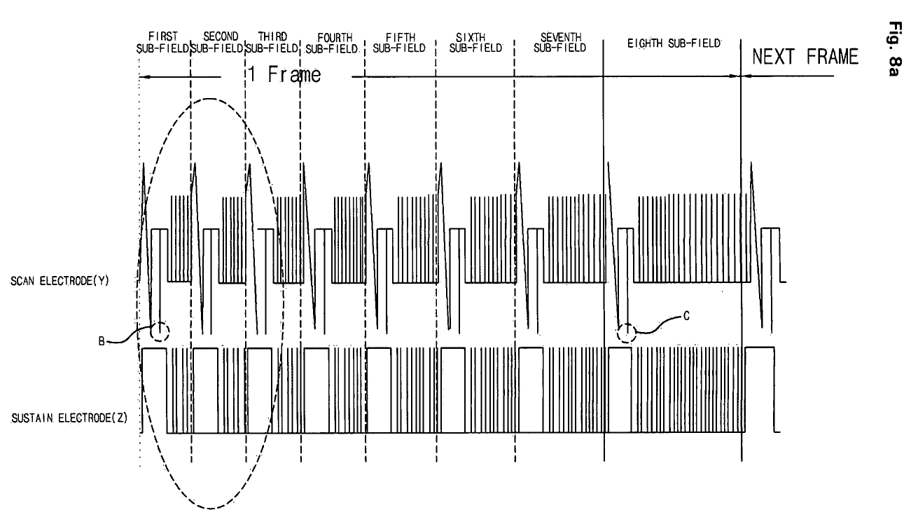

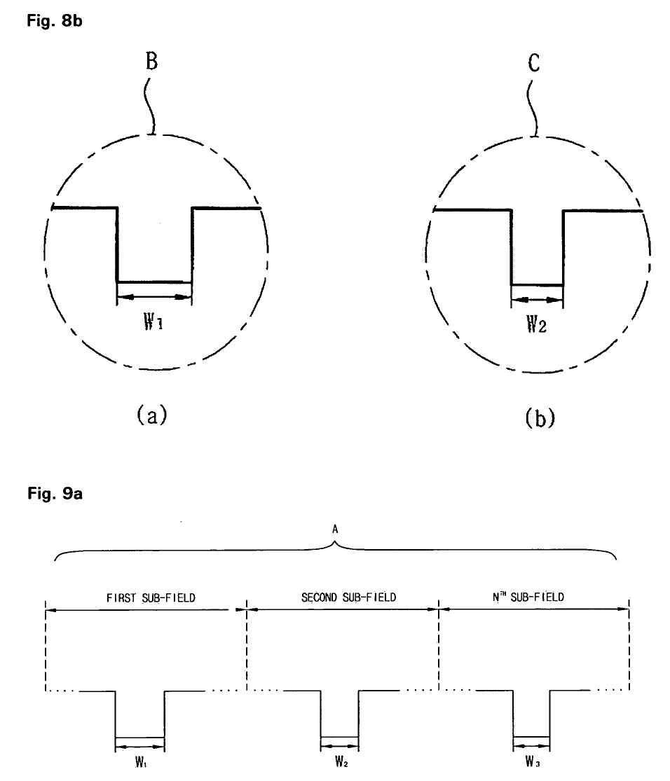

As shown in FIG. 7, the number of a sub-field in which the width of the scan pulse applied to the scan electrodes in the address period is set to over the second critical time is 1. In a plurality of sub-fields, the width of a scan pulse applied to the scan electrodes in the address period may not be set to less than the first critical time, but can be set to over the second critical time. This driving method will be described with reference to FIGS. 8a and 8b.

FIGS. 8a and 8b illustrate a driving method in which the width of a scan pulse applied to scan electrodes in an address period is over a second critical time in a plurality of sub-fields.

Referring to FIG. 8a, sub-fields in which the width of a scan pulse applied to the scan electrodes in the address period is set to over the second critical time is at least one or more. For example, in a total of three sub-fields, the width of the scan pulse is set to be over the second critical time, as shown in FIG. 8a. In the remaining sub-fields, the width of a scan pulse applied to the scan electrodes in the address period is set to less than the first critical time.

As described above, sub-fields in which the width of a scan pulse applied to the scan electrodes in the address period are set to over the second critical time. The sub-fields are from the lowest weight subfield to a predetermined number of subfields in ascending order of weight. That is, as shown in FIG. 8a, in the case of a frame including sub-fields from a first sub-field to an eighth sub-field in order of a higher weight, the width of a scan pulse applied to the scan electrodes in the address period from the first sub-field having the lowest weight to the third sub-field is set to over the second critical time. The reason why the width of a scan pulse is set to over the second critical time in a predetermined number of sub-fields in order by weight, as described above, is also to stabilize an address discharge in sub-fields having a low weight.

As also shown in FIG. 8a, when sub-fields in which the width of a scan pulse applied to the scan electrodes in the address period is over the second critical time. The sub-fields are from the lowest weight subfield to a predetermined number of subfields in ascending order of weight. The reason why a pulse having a scan pulse width of over the second critical time is applied from the first sub-field to the third sub-field as described above is that sub-fields from the above first sub-field to the third sub-field are sub-fields with a low gray level. Sub-fields in which the width of a scan pulse applied in the address period is set to over the second critical time, are indicated by a region A.

Referring to FIG. 8b, assuming that the width of a scan pulse applied to the scan electrode during the address period in the first sub-field of the sub-fields in the region A of FIG. 8a is W1 at (a), the width of a scan pulse applied to the scan electrode during the address period of the remaining sub-fields other than the sub-fields of the region A can be W2 as in (b). In this case, the relationship W1>W2 is established.

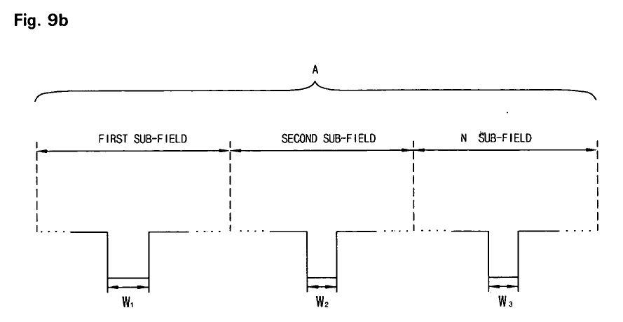

It has been shown and described above that in sub-fields in which the width of the scan pulse applied to the scan electrodes during the address period is set to over the second critical time, the width of a scan pulse is set to the same in all of the sub-fields. Unlike the above, the width of the scan pulse of one sub-field can be set to be different from those of the remaining sub-fields. This driving method will be described with reference to FIGS. 9a and 9b.

FIGS. 9a and 9b illustrate the relationship of a scan pulse between sub-fields in which the width of the scan pulses applied to scan electrodes in an address period is over a second critical time.

Referring first to FIG. 9a, in the case where sub-fields in which the width of a scan pulse applied to the scan electrodes in the address period is over the second critical time is plural, i.e., in the case where the width of a scan pulse applied to the scan electrodes during the address period in first, second and third sub-fields is set to over the second critical time, as shown in FIG. 8a, the width of a scan pulse in the first sub-field having the lowest weight, of the first, second and third sub-fields, is set to be the widest, the width of a scan pulse in the second sub-field having the second lowest weight, of the first, second and third sub-fields, is set to be the second widest, and the width of a scan pulse in the third sub-field having the highest weight, of the first, second and third sub-fields, is set to be the narrowest.

In other words, in a plurality of sub-fields where the width of a scan pulse is set to over the second critical time, the width of a scan pulse applied to the scan electrodes in the address period is different on a sub-field basis. The relationship W1>W2>W3 is established. In FIG. 9a, the width of a scan pulse applied to the scan electrodes in the address period in the remaining sub-fields other than the first, second and third sub-fields is set to over the second critical time.

In a plurality of sub-fields where the width of a scan pulse applied to the scan electrodes in the address period is different on a sub-field basis, as described above, the width of a scan pulse applied to the scan electrodes in the address period can be increased as the weight becomes lower. That is, as described above, W1 is greater than the subsequent W2 and W3.

The width of a scan pulse in at least one of sub-fields in which the width of a scan pulse is set to over the second critical time can be set to different from the width in the remaining sub-fields.

Referring to FIG. 9b, in the case where sub-fields in which the width of a scan pulse applied to the scan electrodes in the address period is set to over the second critical time is plural, i.e., in the case where the width of a scan pulse applied to the scan electrodes during the address period in first, second and third sub-fields is set to over the second critical time, as shown in FIG. 8a, the width of a scan pulse in the first sub-field having the lowest weight, of the first, second and third sub-fields, is set to be wider than those of the remaining sub-fields, and the width of a scan pulse in subsequent sub-fields, i.e., the second and third sub-fields is set to be narrower than those of the first sub-field. The relation W1>W2=W3 is established.

the sub-fields in which the width of the scan pulse is set to over the second critical time, as described above, can be determined based on the number of sustain pulses in the sustain period. In other words, a sub-field having a small number of sustain pulses is a sub-field with a low gray level, and a sub-field having a large number of sustain pulses is a sub-field with a high gray level. As described above, since the weight of a sub-field is decided depending on the number of sustain pulses, the reference to select sub-fields in which the width of a scan pulse applied to the scan electrodes during the address period is set to be over the second critical time is set as the number of sustain pulses. The width of the scan pulse in sub-fields having a smaller number of sustain pulses than the set number of sustain pulses as described above is set to over the second critical time.

In this case, the critical number can be 50% or less, of the total number of sustain pulses used in one frame. The critical number can also be 30% or less of the total number of sustain pulses used in one frame.

For example, in the case where a total of 1000 sustain pulses are used in one frame, a sub-field that uses sustain pulse of 30% or less, of the total number of sustain pulses used in one frame, i.e., 300 in number is selected. A difference between the lowest voltage of a set-down pulse and a voltage of a scan pulse in the selected sub-field is set to be greater than those of the remaining sub-fields.

The driving method, which has been described in detail above, according to the present invention can be applied both to selective writing mode and the selective erasing mode. The driving method of the present invention can even be applied to even a case where both sub-fields of the selective writing mode and sub-fields of the selective erasing mode are comprised.

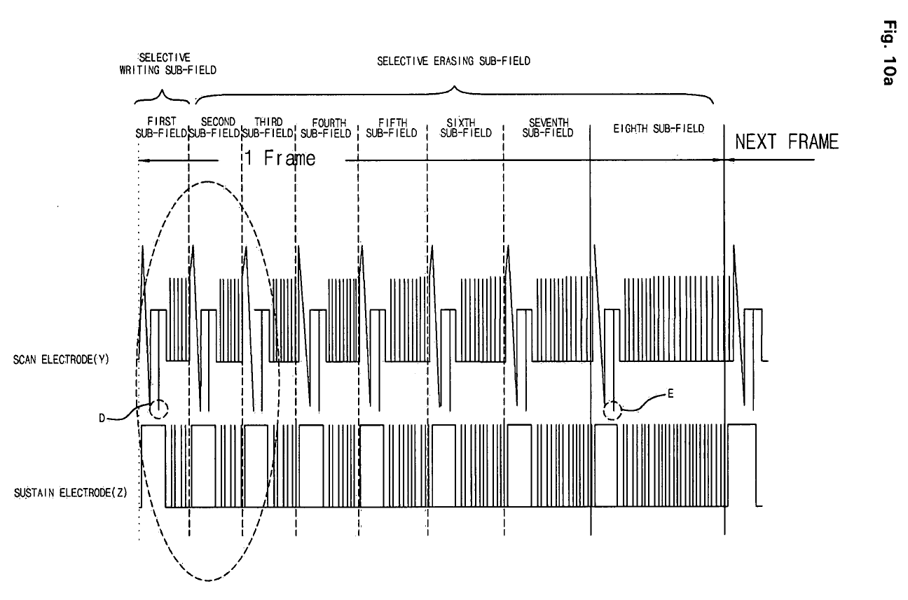

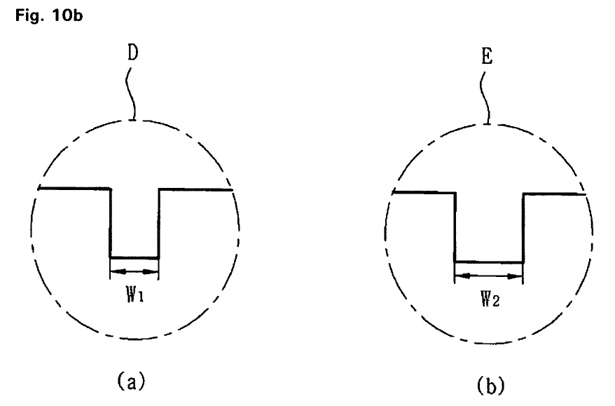

This driving method will be described with reference to FIGS. 10a and 10b.

FIGS. 10a and 10b illustrate a driving method when sub-fields of one frame comprise both sub-fields of the selective writing mode and sub-fields of the selective erasing mode.

From FIG. 10a, both selective writing sub-fields and selective erasing sub-fields are comprised in a frame. For example, as shown in FIG. 10a, a first sub-field is a selective writing sub-field having a relatively high reset pulse, and the remaining sub-fields, i.e., second, third, fourth, fifth, sixth, seventh and eighth sub-fields are selective erasing sub-fields having a relatively low reset pulse.

Even in this case, for example, as shown in FIG. 10b, in the first sub-field, i.e., the selective writing sub-field, the width W1 of the scan pulse of a region D is set to less than the first critical time. In the eighth sub-field, i.e., one of the selective erasing sub-fields, the width W2 of the scan pulse of a region E is set to over the second critical time.

When considering that the amount of a reset pulse of the selective writing sub-field is greater than that of the selective erasing sub-field, the width of a scan pulse in the selective writing sub-field can be set to less than the first critical time, and the width of a scan pulse in at least one of the selective erasing sub-fields, which has a relatively low weight, can be set to over the second critical time.

As described above, the present invention stabilizes an unstable discharge in low gray level sub-fields generated at the time of confined driving by setting the width of a scan pulse applied in an address period.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A plasma display apparatus, comprising:
a plasma display panel comprising a plurality of scan electrodes;
a scan driver for driving the scan electrodes; and
a scan pulse controller for controlling the scan driver to set the width of a scan pulse applied to the scan electrodes in an address period of at least one of a plurality of sub-fields to be less than a first critical time.

2. The plasma display apparatus as claimed in claim 1, wherein the first critical time is 1.1 μs.

3. The plasma display apparatus as claimed in claim 1, wherein the scan pulse controller controls the width of a scan pulse applied to the scan electrodes in an address period of at least one of the remaining sub-fields, other than a sub-field in which the width of a scan pulse applied to the scan electrodes in an address period is set to be less than the first critical time, of the plurality of sub-fields, to be more than a second critical time.

4. The plasma display apparatus as claimed in claim 3, wherein the second critical time is twice the first critical time.

5. The plasma display apparatus as claimed in claim 4, wherein the first critical time is 2.0 μs.

6. The plasma display apparatus as claimed in claim 3, wherein a subfield in which the scan pulse whose width is more than the second critical time is applied to the scan electrode in the address period is from the lowest weight subfield to a predetermined number of subfields in ascending order of weight.

7. The plasma display apparatus as claimed in claim 6, wherein a sub-field in which the scan pulse whose width is more than the second critical time is applied to the scan electrodes in the address period is from the lowest weight subfield to a third sub-field in ascending order of weight.

8. The plasma display apparatus as claimed in claim 3, wherein a sub-field in which the width of the scan pulse applied to the scan electrodes in the address period is more than the second critical time is plural, and the scan pulse controller sets the width of the scan pulse applied to the scan electrodes in the address period of at least one of the plurality of sub-fields to be different from the width of the scan pulse in remaining sub-fields.

9. The plasma display apparatus as claimed in claim 3, wherein a sub-field in which the width of the scan pulse applied to the scan electrodes in the address period is more than the second critical time is plural, and the scan pulse controller sets the width of the scan pulse applied to the scan electrodes in the address period to be different from each other on a sub-field basis, in the plurality of sub-fields.

10. The plasma display apparatus as claimed in claim 9, wherein the scan pulse controller increases the width of the scan pulse applied to the scan electrodes in the address period as the weight, in the plurality of sub-fields in which the width of the scan pulse applied to the scan electrodes in the address period is different from each other on a sub-field basis.

11. The plasma display apparatus as claimed in any one of claims 3 to 10, wherein a sub-field in which the width of a scan pulse applied to the scan electrodes in an address period is set to be over the second critical time, of the plurality of sub-fields uses the number of sustain pulses, which is less than a critical number of sustain pulses.

12. The plasma display apparatus as claimed in claim 11, wherein the critical number is 50% or less of a total number of sustain pulses used in one frame.

13. The plasma display apparatus as claimed in claim 12, wherein the critical number is 30% or less of a total number of sustain pulses used in one frame.

14. The plasma display apparatus as claimed in claim 1, wherein a sub-field in which the width of the scan pulse applied to the scan electrodes in the address period is less than the first critical time is a selective writing sub-field or a selective erasing sub-field.

15. The plasma display apparatus as claimed in claim 1, wherein a sub-field in which the width of the scan pulse applied to the scan electrodes in the address period is over the second critical time is a selective writing sub-field or a selective erasing sub-field.

16. An apparatus for driving a plasma display panel including a plurality of scan electrodes, comprising:
a scan driver for driving the scan electrodes; and
a scan pulse controller for controlling the scan driver to set the width of a scan pulse applied to the scan electrodes in an address period of at least one of a plurality of sub-fields to be less than a first critical time.

17. A plasma display panel on which images are displayed with each of a plurality of sub-fields being divided into a reset period, an address period and a sustain period and a predetermined driving pulse being applied in each of the periods,
wherein the width of a scan pulse applied to a scan electrodes in the address period of at least one of the plurality of sub-fields is set to be less than a first critical time.

18. A plasma display apparatus, comprising:
a plurality of scan electrode; and
controller for setting the width of a scan pulse applied to a scan electrodes to be less than a first critical time in an address period of at least one of the plurality of sub-fields.

19. A plasma display apparatus comprising a driver that applies a driving pulse to a plurality of scan electrodes formed in a panel,
wherein the driver sets the width of a scan pulse applied to a scan electrodes in an address period of at least one of a plurality of sub-fields to be less than a first critical time.

20. A method of driving a plasma display apparatus, which is driven with a plurality of sub-fields being divided into a reset period, an address period and a sustain period, the method comprising:
Setting the width of a scan pulse applied to a scan electrodes in the address period of at least one of the plurality of sub-fields to be less than a first critical time.
